(19) United States
(12) Patent Application Publication
(10) Pub. No.: US 2007/0286407 A1
(43) Pub. Date: Dec. 13, 2007

(54) Terminal apparatus

(75) Inventor: Toshiaki Takahashi, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/802,993

(22) Filed: May 29, 2007

(30) Foreign Application Priority Data
May 29, 2006 (JP) 2006-148024

(51) Int. Cl. H04M 1/00; H04M 9/00

(52) U.S. Cl. 379/413.03; 379/413.01

(57) ABSTRACT

According to one embodiment, a terminal apparatus includes a telephony application function which converts a first voice signal input from a voice input unit into a second voice signal to be transmitted on a first communication line by a converter, and converts the second voice signal received from the first communication line into the first voice signal by the converter, a connector which connects a second communication line to transmit the first voice signal, and a processor which treats the first voice signal input from the voice input unit to selectively derived to the converter or the second communication line in response to a use request for a line, and treats the first voice signal output from the converter or the second communication line.

### CROSS-REFERENCE TO RELATED APPLICATIONS

This application is based upon and claims the benefit of priority from Japanese Patent Application No. 2006-148024, filed May 29, 2006, the entire contents of which are incorporated herein by reference.

### BACKGROUND

1. Field

One embodiment of the present invention relates to a terminal apparatus which has a telephony application function capable of being connected to, for example, an Internet protocol (IP) network to transmit voice packets.

2. Description of the Related Art

In recent years, a system, which connects IP telephone sets each having speech processing functions and media information processing functions to an IP network, such as a local area network (LAN) and the Internet, also connects the IP network to an analog telephone network via a main apparatus or a gateway, and enables communications among IP telephone sets, and among the IP telephone sets and the analog telephone network by applying address conversions, etc., at the gateway or the main apparatus, has suggested.

Meanwhile, in the forgoing system, the places with the IP telephone sets set up thereat and the places with the gateway device set up thereat are different from one another, for instance, the IP telephone sets are set up in Osaka, and the gateway is set up in Tokyo, and the system has a merit to avoid making long distance phone calls by calling from the IP telephone sets in Osaka to the analog telephone network. However, it being hard to specify the positions of originating call sources on the IP network, the system cannot urgently report to appropriate institutes (telephone sets).

Therefore, in a conventional manner, the system has to annex analog telephone sets to be connected to the analog telephone network in addition to the IP telephone sets, then, an economical burden on a user of an IP telephone set increases.

Conventionally, a method, which makes an Internet telephone set have a telephone circuit with a function of an analog telephone set of a public line built-in, and makes a selection circuit switch to the Internet or to the public line, has been an possible approach (for example, Jpn. Pat. Appln. KOKAI Publication No. 2004-235779).

However, the method becomes large in size because the internet telephone set includes the selection circuit to switch the connection thereof to the Internet or to the public line.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view of a system to which IP telephone sets regarding the first embodiment of the invention applied thereto;

FIG. 2 is an exemplary appearance view of the IP telephone set depicted in FIG. 1,

FIG. 3 is an exemplary block diagram depicting a circuit configuration of the IP telephone set depicted in FIG. 1;

FIG. 4 is an exemplary block diagram depicting a circuit configuration of the IP telephone set as the second embodiment of the invention;

FIG. 5A is an exemplary view depicting an example of data, showing a correspondence relation of countries and reception speech amplifier gains, to be stored in the flash memory shown in FIG. 4;

FIG. 5B is an exemplary view depicting an example of data, showing a correspondence relation of countries and transmission speech amplifier gains, to be stored in the flash memory shown in FIG. 4;

FIG. 6A is an exemplary view depicting an another example of data, showing a correspondence relation of countries and reception speech amplifier gains, to be stored in the flash memory shown in FIG. 4;

FIG. 6B is an exemplary view depicting an another example of data, showing a correspondence relation of countries and transmission speech amplifier gains, to be stored in a flash memory shown in FIG. 4;

FIG. 7A is an exemplary view depicting an example of data, showing a correspondence relation of countries in which the IP telephone is installed and reception speech amplifier gains, to be stored in the flash memory shown in FIG. 4, as a modified example of the second embodiment of the invention; and

FIG. 7B is an exemplary view depicting an example of data, showing a correspondence relation of countries and transmission speech amplifier gains, to be stored in the flash memory shown in FIG. 4, as a modified example of the second embodiment of the invention.

### DETAILED DESCRIPTION

Various embodiments according to the invention will be described hereinafter with reference to the accompanying drawings. In general, according to one embodiment of the invention, a terminal apparatus, comprising: a telephony application function which makes a first communication line be connectable, converts a first voice signal input from a voice input unit into a second voice signal to be transmitted on the first communication line by a converter to transmit it to the first communication line, and converts the second voice signal received from the first communication line into the first voice signal by the converter to output it from a voice output unit; a connector which connects a second communication line to transmit the first voice signal; and a processor which is provided in common to the first and the second communication lines, treats the first voice signal output from the voice input unit to selectively derived to the converter or the second communication line in response to a use request for a line, and treats the first voice signal output from the converter or the second communication line to output it to the voice output unit.

### First Embodiment

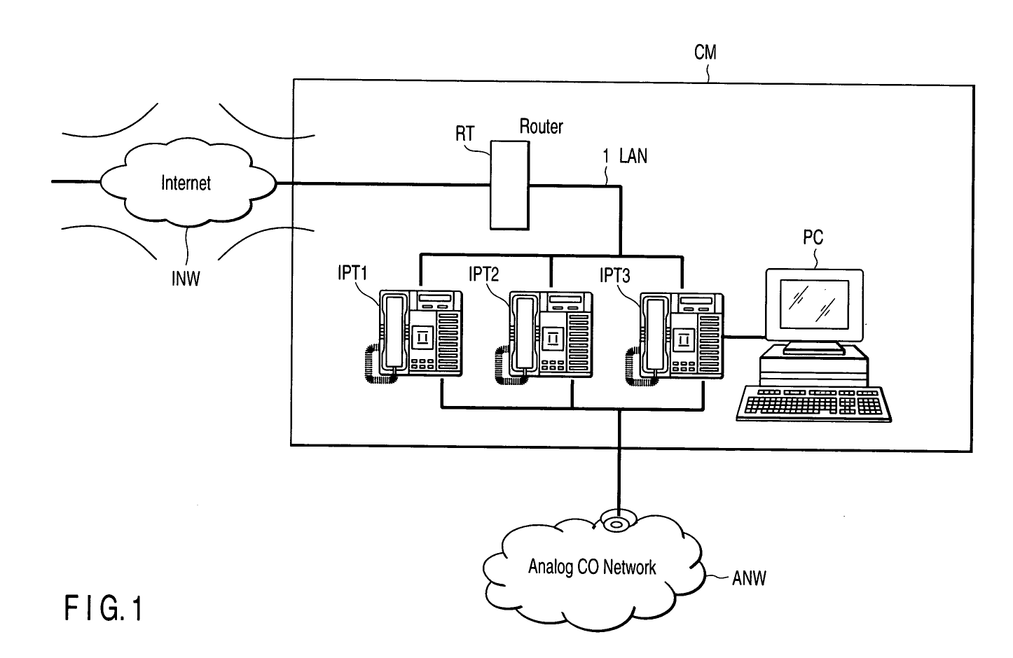

FIG. 1 is a schematic configuration view of a system to which IP telephone sets regarding to the invention applied thereto, and the symbol CM indicates a user system, such as a house or an enterprise.

The user system CM includes a plurality of IP telephone sets IPT1-IPT3. For the purpose of simplicity, FIG. 1 illustrates only three sets of the IP telephone sets IPT1-IPT3. Among of them, the IP telephone set IPT3 connects a personal computer PC thereto.

The IP telephone sets IPT1-IPT3 are connected to the Internet INW via a LAN 1 and a router RT. The IP telephone sets IPT1-IPT3 are connected to an analog common (CO) network ANW.

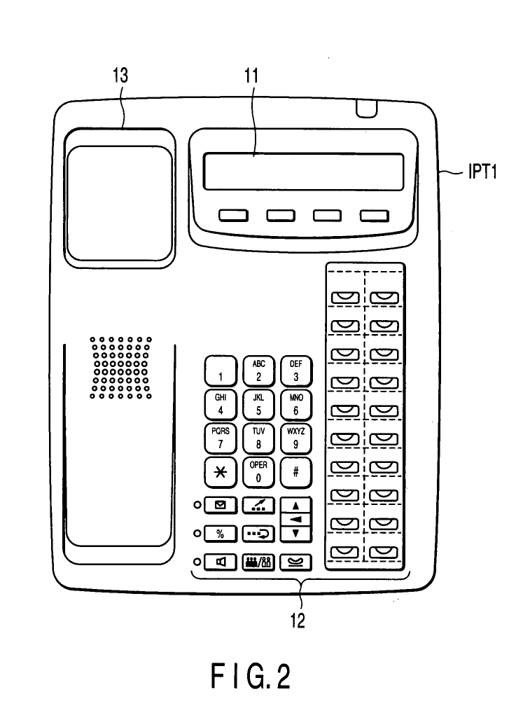

FIG. 2 is an appearance view showing the IP telephone sets IPT1-IPT3. Here, the IP telephone set IPT1 will be described as a representative.

A display unit 11 using a liquid crystal display (LCD), etc., is disposed on a front face panel unit of the IP telephone set IPT1. Further, a key matrix 12 composed of a dial key, a function key, etc., are disposed on a lower panel unit of the display unit 11. A handset 13 with a loud-speaker and a microphone is disposed on a left side of the front face panel unit of the IP telephone set IPT1.

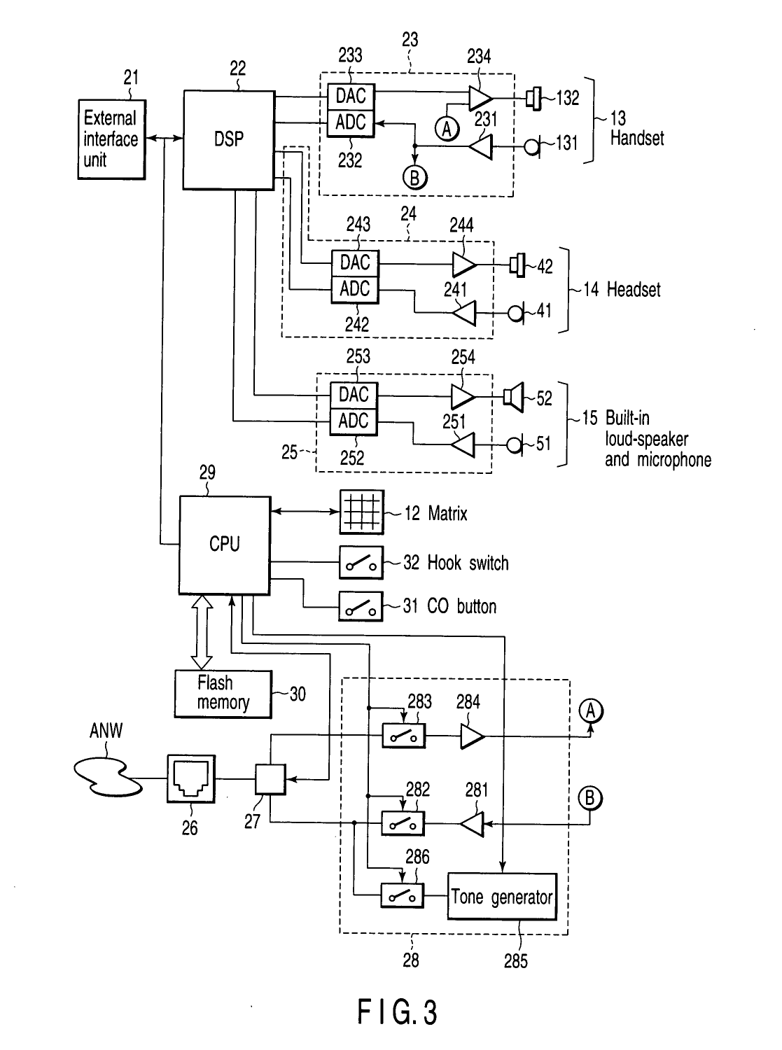

Meanwhile, the circuit configuration of the IP telephone set IPT1 is described below. FIG. 3 is a block diagram showing the configuration.

The IP telephone set IPT1 includes an external interface unit 21, a digital signal processor (DSP) 22, voice input/output interface units 23, 24 and 25 (hereinafter, referred to as interface units 23, 24 and 25), a modular jack 26, an analog CO interface unit 27 (hereinafter, referred to as interface unit 27), an analog voice input/output interface unit 28 (hereinafter, referred to as interface unit 28), a central processing unit (CPU) 29, and a flash memory 30.

The external interface unit 21 performs interface operations related to the LAN 1. That is, the external interface 21 extracts a voice packet and control data from a transmission packet transmitted from the LAN 1, and supplies the voice packet to the DSP 22 and the control data to the CPU 29. The external interface unit 21 multiplexes the data supplied from the CPU 29 with the voice packet supplied from the DSP 22 to transmit it to the LAN 1.

The DSP 22 converts the voice packet supplied from the external interface unit 21 into a digital reception speech voice signal to supply it to the interface unit 23. The DSP 22 converts the digital transmission speech voice signal input from the voice input/output interface unit 23 into a voice packet of which the handling is possible on the LAN 1 to supply it to the external interface unit 21.

A microphone 131 and a loud-speaker 132 of the handset 13 are connected to the interface unit 23. The interface unit 23 amplifies, by a prescribed level, the transmission speech voice signal input from the microphone 131, converts it into a digital transmission speech voice signal through an analog-digital converter (ADC) 232, and then, inputs it to the DSP 22. The interface unit 23 converts the reception speech voice signal output from the DSP 22 into an analog reception speech voice signal through a digital-analog converter (DAC) 233, and then, amplifies it by a loud-speaker amplifier 234 to acoustically reproduce it from a loud-speaker 132.

A microphone 41 and a loud-speaker 42 of a headset 14, wirelessly connected to the IP telephone set IPT1, are connected to the interface unit 24. Further, a microphone 51 and a loud-speaker 52 built in the IP telephone set IPT1 are connected to the interface unit 25.

An analog CO network ANW is connected to the modular jack 26 if necessary.

The interface unit 27 conducts interface operations related to the analog CO network ANW connected through the modular jack 26. In other words, the interface unit 27 mainly houses a direct current loop circuit, an incoming call detection circuit, and two-line to four-line conversion circuit, supplies a voice signal to the interface unit 28, and supplies a control signal to the CPU 29 in the transmission signal transmitted from the analog CO network ANW, respectively. The interface unit 27 transmits the voice signal supplied from the interface unit 28 to the analog CO network ANW.

The interface unit 28 amplifies, by a prescribed level, the transmission speech voice signal input from the microphone 131, and inputs it to the interface unit 27 through an analog switch 282. The interface unit 28 amplifies the reception speech voice signal output from the interface unit 27 by a reception speech amplifier 284 through an analog switch 283 to output it to the interface unit 23. The reception speech voice signal is then acoustically reproduced from the loud speaker 132.

The CPU 29 carries out control of each component of the IP telephone set IPT1 and communication processing to and from the LAN 1 or the analog CO network ANW through software processing. When accepting an analog line use request from a user by means of the key matrix 12 or CO button 31, the CPU 29 turns the analog switches 282 and 2830N. In usual, the CPU 29 has turned the analog switches 282 and 283 OFF. Furthermore, when performing a dual tone multi frequency (DTMF) transmission through analog CO network ANW, the CPU 29 transmits the DTMF signal generated from a tone generator 285 to the analog CO network through the analog switch 286. At this moment, the analog switch 282 is controlled to be open.

Next, operations in the given configuration will be described.

It is presumed that a user of the IP telephone set IPT1 depresses the CO button 31 at the IP telephone set IPT1 to generate an analog CO speech request. The CPU 29 then turns the analog switches 282 and 283 ON, and controls the DSP 22 so as not to transmit the voice signal on the IP telephone side to the ADC 232 and the DAC 233 in the IP DSP 22. So that, the CPU 29 may switch the speech between the analog CO speech and the IP telephone speech.

As mentioned above, in the first embodiment, the IP telephone set IPT1 has the modular jack 27 and the analog co interface unit 27 to connect the analog CO network ANW built-in, and also the CPU 29 controls the DSP 22, and the analog switches 282 and 283, then, the IP telephone set and the analog CO communication shares the microphone 131, the loud speaker 132, the microphone 231 and the loud-speaker amplifier 234 of the handset 13.

Accordingly, there is no need to separately prepare a microphone, a loud-speaker, a microphone amplifier and a loud-speaker amplifier for the analog CO speech, thus, the IP telephone set IPT1 may be configured with relative ease and in a small size.

According to the first embodiment, the user system CM may eliminate an analog switch to be directly connected to the handset 13.

### Second Embodiment

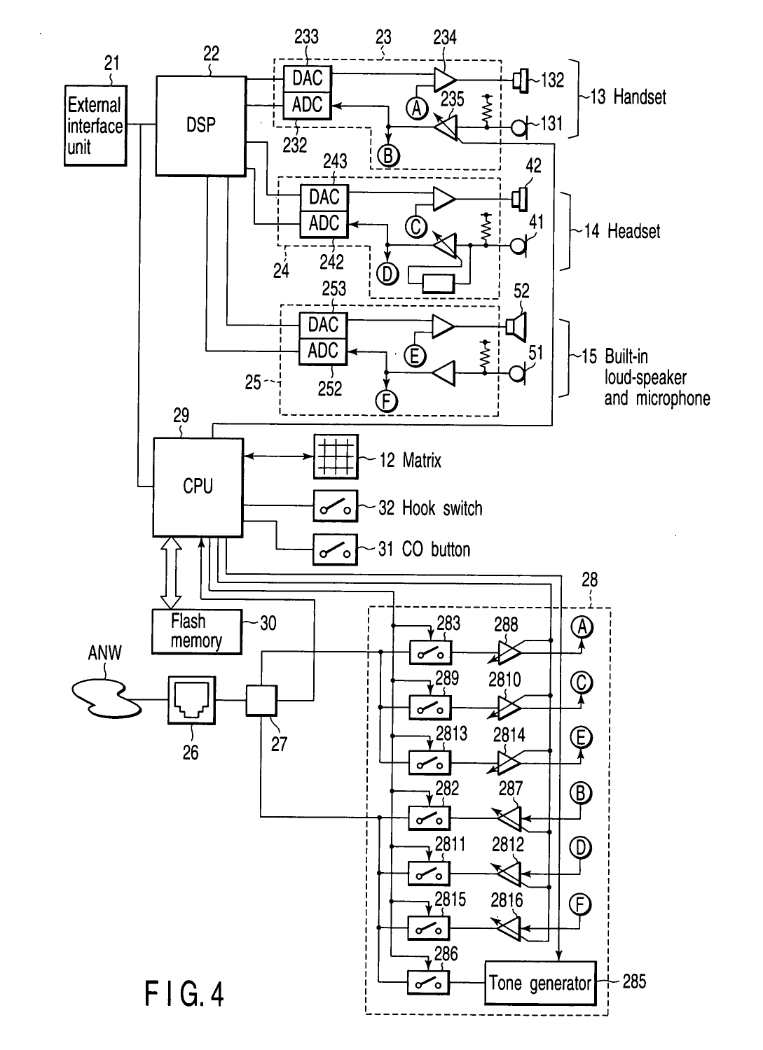

FIG. 4 is a block diagram illustrating a circuit configuration of the IP telephone set IPT1 as the second embodiment of the invention. In FIG. 4, the same components as those of FIG. 3 are designated by the identical symbols and detailed descriptions thereof will be omitted.

In the voice input/output interface unit 23, a microphone amplifier 235 possible to arbitrary control an amplifier gain is interposed and connected between the microphone 131 and the A-D converter (ADC) 232.

In the interface unit 28, a transmission speech amplifier 287 possible to arbitrary control an amplifier gain is interposed and connected between the microphone 131, the microphone amplifier 235 and the analog switch 282. A reception speech amplifier 288 possible to arbitrary control an amplifier gain is interposed and connected between the loud speaker 132, the loud-speaker amplifier 234 and the analog switch 283.

The CPU 29 controls each amplifier gain of the microphone amplifier 235, the transmission speech amplifier 287 and the reception speech amplifier 288.

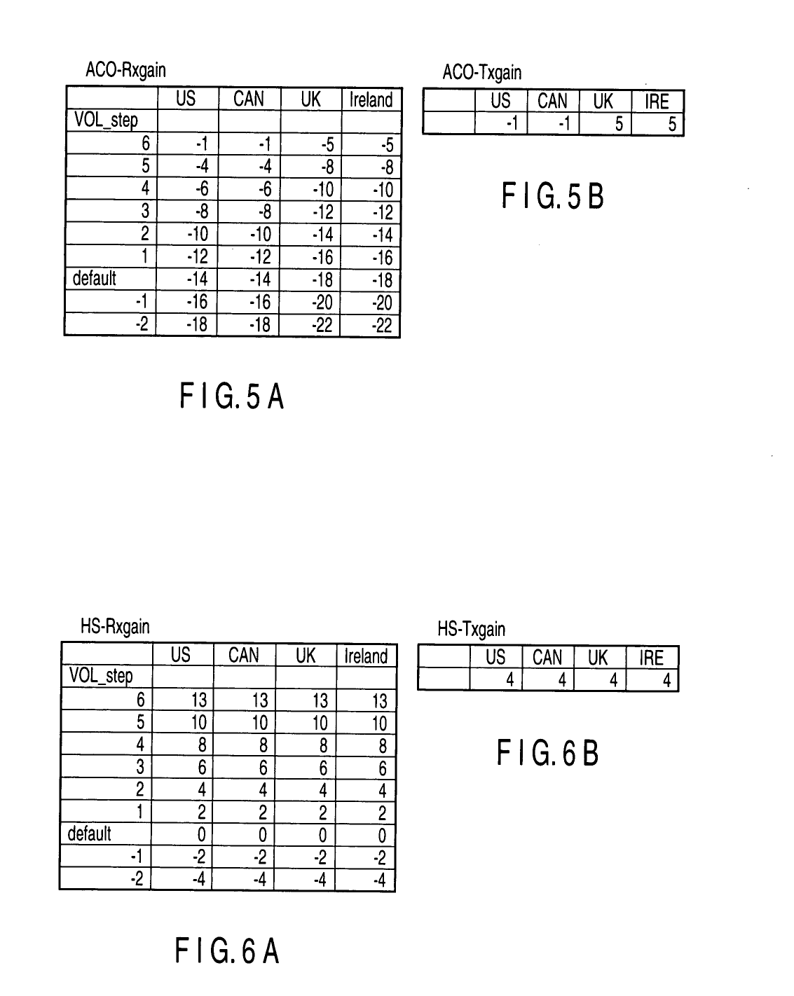

The flash memory 30 stores, as shown in FIG. 5A, the data indicating the correspondence relation of the set up countries and the reception speech amplifier gains to be set in the reception speech amplifier 288. As shown in FIG. 5B, the data showing the correspondence relation of the set up countries and the transmission speech amplifier gains to be set in the transmission amplifier 287 is stored in the flash memory 30.

Further, as shown in FIG. 6A, the data showing the correspondence relation of the set up countries and the reception speech amplifier gains to be set in the DSP 22 is stored in the flash memory 30. As shown in FIG. 6B, the data indicating the correspondence relation of the set up countries and the transmission speech amplifier gains to be set in the microphone amplifier 235 is stored in the flash memory 30.

Next to this, operations in the aforementioned configuration will be described.

It is assumed that the user of the IP telephone set IPT1 generates an analog CO speech request by depressing the CO button 31 at the IP telephone set IPT1. At this moment, if the set up country is, for instance, the United States of America, the user inputs the country ID “US” by means of the key matrix 12.

The CPU 29 then turns the analog switches 282 and 2830N, and also reads out the transmission speech amplifier gain “−1” corresponding to the “US” in the flash memory 30. The CPU 29 then controls the amplifier gain of the transmission speech amplifier 287 so as to match with the gain “−1”, reads out the reception speech amplifier gain “−8” corresponding to “US” in the flash memory 30, and controls the amplifier gain of the reception speech amplifier 288 so as to match with gain “−8”.

In contrast, when the user operates the key matrix 12 to set a loud-speaker volume to an arbitrary sound volume value “5”, the CPU 29 reads out the reception speech amplifier gain “−4” from the flash memory 30 to control the amplifier gain of the reception amplifier 288 by matching to the reception speech amplifier gain “−4”.

The interface unit 28 may be shared with the interface unit 24 of the headset 14 by means of an analog switch 289, a reception speech amplifier 2810, an analog switch 2811, and a transmission speech amplifier 2812.

Moreover, the interface unit 28 may be shared with the interface unit 25 of the loud-speaker 52 and the microphone 51 built in the IP telephone set IPT1 by means of an analog switch 2813, a reception speech amplifier 2814, an analog switch 2815 and a transmission speech amplifier 2816.

As mentioned above, in the second embodiment, the IP telephone set IPT1 uses information about the transmission speech amplifier gains and the reception speech amplifier gains by country accumulated and stored in the flash memory 30 to control each amplifier gain of the DSP 22, the microphone amplifier 235, the reception speech amplifier 288 and the transmission speech amplifier 287.

Accordingly, the IP telephone set IPT1 can set a speech level appropriate to the specification of the country in which it is used by a simple operation to specify the country ID when a speech request to the LAN 1 or to the analog CO network ANW is generated. Similarly, the DTMF level is also becomes applicable to the specification of the country.

In the IP telephone set IPT1, its speech level is usually standardized because of the property of the IP, and it becomes a telephone set appropriate to each country in the world; however, in many cases, the analog CO is uniquely defined in its speech level and DTMF level for each country and area, and the IP telephone set often becomes one for the country and area use only. According to this method, a terminal apparatus applicable for each country may be provided although the terminal apparatus is one to be connected with the analog CO network ANW.

Further, as a modified example of the second embodiment, like the foregoing information on the set up country, if the connecting destination on the analog CO network ANW is not a public line but a private branch exchange (PBX) for an enterprise, the line current flowing in a current loop is smaller that that in the public line sometimes. In such a case, the IP telephone set IPT1 takes for a long-distance connection because of the small current, and intends to increase the transmission amplifier gain and the reception speech gain sometimes.

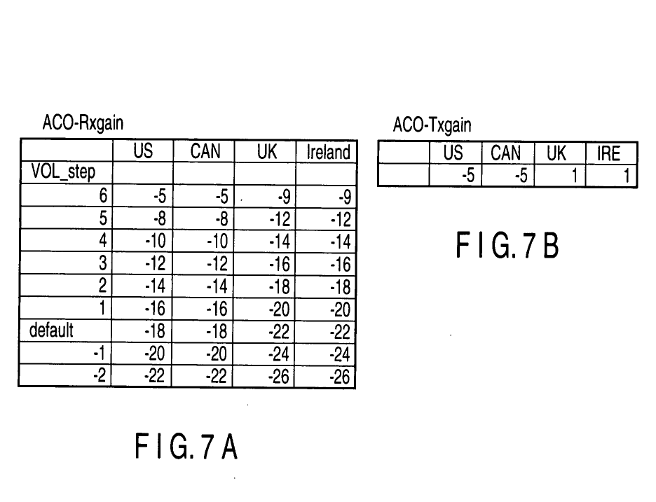

Therefore, in the PBX connection, as shown in FIG. 7A, the IP telephone IPT1 stores the data indicating the correspondence relation of the set up countries and the reception speech amplifier gains so as to set it to the reception speech amplifier 288 in the flash memory 30, and as shown in FIG. 7B, also stores the data indicating the set up countries and the transmission amplifier gains so as to set it to the transmission amplifier 287 in the flash memory 30. Thus, the IP telephone IPT1 becomes possible to change each amplifier gain of the transmission speech amplifier 287 and the reception speech amplifier 288 by connection destination.

Such a storage method of the information referred to as a PBX connection may be set with a manual input from the key matrix 12.

The PBX in a 24-Volt system, the interface unit 27 has a circuit to measure an analog line terminal voltage at the time when the direct-current circuit on the analog line is not closed, and may automatically change the gain by transferring the measurement information to the control circuit in the IP telephone set IPT1.

### Other Embodiment

The invention is not limited to each of the aforementioned embodiments. For example, each embodiment given above having described by taking the IP telephone set as an example, the same possibly goes to a business phone, such as a digital key telephone set. The business phone is also connected to the exclusive PBX (main device) via an exclusive digital line, the main device is connected to another main device via the exclusive line, and another main device makes a transmission to the analog line network sometimes. In this case, the business phone possibly goes the same as the IP telephone set described above. Therefore, the invention is not limited to the IP telephone set, and it includes a digital telephone set for business.

In each of the foregoing embodiments, the invention may be applicable to a personal computer with a telephony application mounted thereon and electronic equipment to treat a voice signal.

Moreover, while the modified example of the second embodiment has been described about the correspondence relation of the combination of the connection destinations and the countries, and the amplifier gains, the IP telephone set may register the data, showing the correspondence relation of the connection destinations and the amplifier gain except the countries, in the flash memory.

Other than this, the invention may be embodied in a variety of other forms for the types and configurations of the terminal device, such as a telephone set, the control procedure of the amplification gain, such as a transmission speech amplifier gain and a reception speech amplifier gain, and the like, within the scope and spirit of the inventions.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A terminal apparatus, comprising:
a telephony application function which makes a first communication line be connectable, converts a first voice signal input from a voice input unit into a second voice signal to be transmitted on the first communication line by a converter to transmit it to the first communication line, and converts the second voice signal received from the first communication line into the first voice signal by the converter to output it from a voice output unit;
a connector which connects a second communication line to transmit the first voice signal; and
a processor which is provided in common to the first and the second communication lines, treats the first voice signal output from the voice input unit to selectively derived to the converter or the second communication line in response to a use request for a line, and treats the first voice signal output from the converter or the second communication line to output it to the voice output unit.

2. The terminal apparatus according to claim 1, wherein
the processor includes:
a voice amplifier which is possible to arbitrary set amplification gains of the voice signal; and
a controller which controls the amplification gains of the voice amplifier in response to the use request.

3. The terminal apparatus according to claim 2, further comprising:
a memory which stores a country correspondence table showing a correspondence relation of country IDs indicating countries in which the second communication line is used and the amplification gains, wherein
the controller referrers to the country correspondence table when a use request for a line including the country IDs is generated, and controls amplification gains of the voice amplifier based on the reference result.

4. The terminal apparatus according to claim 2, further comprising:
a memory which stores a connection destination correspondence table showing a correspondence relation of connection IDs indicating connection destinations on the second communication line and the amplification gains, wherein
the controller referrers to the connection destination correspondence table when a use request for a line including the connection IDs is generated, and controls amplification gains of the voice amplifier based on the reference result.

5. The terminal apparatus according to claim 2, further comprising:
a memory which stores a table showing a correspondence relation of country IDs indicating countries in which the second communication line is used and connection IDs indicating connection destinations on the second communication line, wherein
the controller referrers to the table when a use request for a line including the country IDs and the connection IDs is generated, and controls amplification gains of the voice amplifier based on the reference result.

6. The terminal apparatus according to claim 1, when the first communication line is a packet communication line, and the second communication line is an analog communication line, wherein
the processor treats an analog voice signal input from the voice input unit to selectively derive it to the converter or the analog communication line in response to the use request for the line, and treats the analog voice signal output from the analog communication line to output it to the voice output unit.
